(19) United States
(12) Patent Application Publication
(10) Pub. No.: US 2005/0254781 A1
(43) Pub. Date: Nov. 17, 2005

(54) Recording/reproducing device

(76) Inventors: Satoshi Kajita, Yukuhashi (JP); Kazuyuki Imagawa, Toyonaka (JP); Eiji Fukumiya, Toyonaka (JP)

Correspondence Address: WENDEROTH, LIND & PONACK, L.L.P., 2033 K STREET N. W., SUITE 800, WASHINGTON, DC, 20006-1021, US

(21) Appl. No.: 11/129,368

(22) Filed: May 16, 2005

(30) Foreign Application Priority Data
May 17, 2004 (JP) 2004-145983

(51) Int. Cl. H04N 5/76

(52) U.S. Cl. 386/46; 386/125

(57) ABSTRACT

A judging unit judges an audience in the state of existence or in the state of non-existence and generates non-existence information. Based on the non-existence information generated by the judging unit, a recording/reproducing control unit controls whether to store an image content which is currently inputted into an image recording unit. The recording/reproducing control unit controls whether an image display unit performs simultaneous reproducing of the image content which is stored in the image recording unit, concurrently with the currently-inputted image content, based on the non-existence information of the judging unit. The image content which is failed to be watched is made up with simultaneous reproducing, automatic recording is shortened rationally, and electric power consumption is saved.

### BACKGROUND OF THE INVENTION

1. Field of the Invention

The present invention relates to a recording/reproducing device which automatically stores an image content that an audience fails to watch for a reason of “non-existence”, thereby improving convenience for the audience. In more detail, the present invention aims to solve a subject which has a trade-off relationship between the convenience for the audience and reduction of electric power consumption in this kind of recording/reproducing device.

2. Description of the Related Art

In the field of a recording/reproducing device, in stead of a conventional tape-based recording/reproducing appliance, a digital recording/reproducing device using such as a hard disk and a DVD recording medium with a large capacity has begun to prevail, including some devices which can perform recording and reproducing simultaneously. Generally, an image content to be reproduced is of the past, and an image content to be stored is basically of the present, therefore a time lag (or a time shift) is generated between the image content to be stored and the image content to be reproduced.

By using the time shifting actively, an audience can reproduce later, with improved convenience, an image content which the audience has failed to watch for a reason of “non-existence”, by storing in a recording/reproducing device a currently-inputted image content as much as the capacity of a recording medium of the recording/reproducing device allows. (The meaning of the term “non-existence” will be explained later.) Here, the image content is usually compressed by image encoding and stored on the recording medium. The image content stored in the recording medium is reproduced and decoded to be displayed.

When recording of the currently-inputted image content and reproducing of the image content which was inputted in the past and stored on the recording medium are performed simultaneously, required electric power consumption becomes considerable. It is because the image encoding and decoding require a large amount of calculation, and because an image encoding LSI, a hard disk, and a driving unit of a DVD recoding medium which are mounted in the recording/reproducing device consume a lot of electric power.

In short, automatic recording for as long period of time as possible is desirable for convenience for an audience. On the other hand, for the reduction of electric power consumption, time required in automatic recording should be as short as possible. These points have the trade-off relationship and a measure for harmonizing these points rationally is currently demanded.

Document 1 (published Japanese Patent Application No. 11-242733) discloses an art with regard only to a point of reducing electric power consumption of a display device. That is, the art shoots images in a predetermined distance range from a display by using a camera and judges whether there is a facial image in the shot image. When any facial image cannot be recognized for the predetermined time, a user is regarded as not looking at the display, and the art turns off the display device to reduce electric power consumption.

However, for a recording/reproducing device which performs automatic recording of an image content, when an audience is in a state of non-existence, an electronic power supply cannot be cut. The recording/reproducing device which performs automatic recording of the image content needs to store actively the image content that the audience fails to watch for non-existence. Therefore, Document 1 does not work as reference for harmonizing the two points which are described above.

### OBJECTS AND SUMMARY OF THE INVENTION

An object of the present invention is to provide a recording/reproducing device of which convenience for an audience is high and which can reduce electric power consumption.

A first aspect of the present invention provides a recording/reproducing device, comprising: an image recording unit operable to store a currently-inputted image content; an image display unit operable to display a stored image content stored by the image recording unit and the currently-inputted image content; a judging unit operable to judge whether an audience exists or not, thereby generating non-existence information that includes an item indicating one of states of existence and non-existence of the audience; a recording/reproducing control unit operable, according to the non-existence information generated by the judging unit, to control whether the image recording unit should store the currently-inputted image content, and further operable to control whether the image display unit should concurrently display both the stored image content and the currently-inputted image content; and a timer operable to measure a time when the item of the non-existence information changes from the state of existence to the state of non-existence and a time when the item of the non-existence information changes from the state of non-existence to the state of existence, thereby generating a measured result.

According to the present structure, the recording/reproducing control unit controls whether the image recording unit should store the currently-inputted image content based on the non-existence information of the judging unit. Therefore, it is possible to limit a range of storage of the currently-inputted image content (that is, for simultaneous reproduction) to a time that the non-existence information generated by the judging unit indicates that the audience is in a state of non-existence. Accordingly, the audience can watch later the image content which is inputted when the audience is unable to watch for being in the state of non-existence.

Simultaneous reproduction of the image content which the audience has already watched in a state of existence provides the audience with little merit. The above structure can exclude the image content which the audience has already watched in the state of existence from object image contents of simultaneous reproduction. Accordingly, the useless electric power consumption for the excluded image content (LSI electric power consumption in image encoding/decoding, power consumption required for the driving a recording medium) can be saved.

As a result, the two subject matters mentioned above can be harmonized rationally.

A second aspect of the present invention provides, in addition to the first structure of the present invention, the recording/reproducing device, wherein the recording/reproducing control unit makes the image recording unit begin to store the currently-inputted image content when the item of the non-existence information changes from the state of existence to the state of non-existence, and wherein the recording/reproducing control unit judges, referring to the measured result generated by the timer, whether the image display unit should concurrently display both the stored image content and the currently-inputted image content when the item of the non-existence information changes from the state of non-existence to the state of existence.

According to the present structure, the recording/reproducing control unit can control image storage and display for simultaneous reproduction by using the measured result of the timer.

A third aspect of the present invention provides, in addition to the second structure of the present invention, the recording/reproducing device, wherein the recording/reproducing control unit makes the image display unit begin to concurrently display both the stored image content and the currently-inputted image content when the item of the non-existence information changes from the state of non-existence to the state of existence and when the measured result generated by the timer exceeds a predetermined threshold.

According to the present structure, by comparing the measured result of the timer with a predetermined threshold, simultaneous reproduction can be omitted when an audience is in a state of non-existence only for a moment; therefore, a flicker of a display (repeated ON/OFF of the display in simultaneous reproduction) can be prevented. As a matter of course, when the measured result is beyond the predetermined threshold, the image content, which has been stored in the image recording unit, is reproduced simultaneously when the audience returns and a part of image content which the audience has failed to watch can be made up.

A fourth aspect of the present invention provides, in addition to the second structure of the present invention, the recording/reproducing device, wherein the recording/reproducing control unit makes the image display unit end to concurrently display both the stored image content and the currently-inputted image content when a reproducing time of the stored image content catches up with a reproducing time of the currently-inputted image content.

According to the present structure, when the reproducing time of the image content simultaneously reproduced from the image recording unit and displayed on the image display unit catches up with the reproducing time of the currently-inputted image content, the simultaneous reproduction ends and useless electric power consumption can be reduced. The simultaneous reproduction may preferably compress the currently-inputted image content on the time axis (for example, doubling the reproduction speed). In this case, the reproducing time of the simultaneous reproduction catches up with the reproducing time of the currently-inputted image content in course of time.

A fifth aspect of the present invention provides, in addition to the fourth structure of the present invention, the recording/reproducing device further comprising: a commercial judging unit operable to judge whether the currently-inputted image content is an image content of a commercial, wherein the recording/reproducing control unit makes the image recording unit suspend storage of the currently-inputted image content while the commercial judging unit judges that the currently-inputted image content is the image content of the commercial, the storage having begun when the item of the non-existence information changed from the state of existence to the state of non-existence.

According to the present structure, based on a judgment result of the commercial judging unit, the recording/reproducing control unit interrupts the image recording unit in storing the commercial parts. That is, storing time of the image recording unit is shortened as much as the commercial time, and the storing time of the image recording unit becomes easy to catch up with the reproducing time of the currently-inputted image content. Therefore, the simultaneous reproduction can be ended promptly and useless electric power consumption can be reduced. This point is applicable to a case where the speed of the simultaneous reproduction is the same as the speed of the currently-inputted image content. That is a case where the simultaneous reproduction is not compressed on the time axis.

Moreover, except for a special case in which an audience wants to watch commercials willingly, there is little dissatisfaction of the audience even when the simultaneous reproduction of commercials is omitted, thereby, this structure gives priority to the reduction of electric power consumption.

A sixth aspect of the present invention provides, in addition to the fourth structure of the present invention, the recording/reproducing device further comprising: an image erasing unit operable to erase an image content stored by the image recording unit, wherein the recording/reproducing control unit makes the image erasing unit erase an image content that has been stored by the image recording unit and has become unnecessary for concurrently displaying both the stored image content and the currently-inputted image content.

According to the present structure, when the image erasing unit deletes the image content which has been reproduced simultaneously from the image recording unit, a free space of the image recording unit can be secured and this free space can be allocated to other purposes.

A seventh aspect of the present invention provides, in addition to the first structure of the present invention, the recording/reproducing device, wherein the judging unit includes: a button operable to notify the recording/reproducing control unit that the button has been pressed down by the audience.

According to the present structure, the audience can notify actively the recording/reproducing device that the state is changed from the non-existence to the existence by pressing down the button, and this notification is reflected to a processing of the recording/reproducing control unit.

An eighth aspect of the present invention provides, in addition to the first structure of the present invention, the recording/reproducing device, wherein the judging unit includes: an infrared sensor operable to notify the recording/reproducing control unit that the infrared sensor has been shaded by the audience.

According to the present structure, when the infrared sensor is shaded, the audience can notify the recording/reproducing device that the state is changed from the non-existence to the existence without any active action, and the notification is reflected to a processing of the recording/reproducing control unit.

A ninth aspect of the present invention provides, in addition to the first structure of the present invention, the recording/reproducing device, wherein the judging unit includes: a camera operable to shoot a predetermined area to generate an camera image; and a person extracting unit operable to judge whether the audience exists in the camera image generated by the camera.

A tenth aspect of the present invention provides, in addition to the ninth structure of the present invention, the recording/reproducing device, wherein the person extracting unit includes: a facial image judging unit operable to detect a facial image in the camera image generated by the camera.

An eleventh aspect of the present invention provides, in addition to the ninth structure of the present invention, the recording/reproducing device, wherein the person extracting unit includes: an eye-direction judging unit operable to detect an eye-direction of the audience in the camera image generated by the camera.

According to these present structures, when the person extracting unit extracts a person image, the audience can notify the recording/reproducing device that the state is changed from the non-existence to the existence without any active action, and the notification is reflected to a processing of the recording/reproducing control unit.

A twelfth aspect of the present invention provides, in addition to the first structure of the present invention, the recording/reproducing device, wherein the image recording/reproducing device is mounted in an automobile, and wherein the judging unit includes: a speed measuring unit operable to measure a speed of the automobile to generate speed information, thereby notifying the recording/reproducing control unit of the speed information.

According to the present structure, since the speed measuring unit measures the speed of the automobile, the speed information is notified to the recording/reproducing unit without any active action of the audience. For example, when a driver is driving the automobile, the driver's attention becomes distracted if the driver performs operation for recording/reproducing, which may cause a traffic safety problem. Therefore, the display of a currently-inputted image content is usually forbidden. In this case, a passenger of the automobile fails to watch the image content. In such a case, the image content which the passenger has failed to watch is stored without any special action. When the automobile stops and is in a safe state, the passenger can watch the image content which the passenger has failed to watch.

A thirteenth aspect of the present invention provides, in addition to the first structure of the present invention, the recording/reproducing device, wherein the recording/reproducing control unit operable, according to a change of a difference between a reproducing time of the currently-inputted image content and a reproducing time of the stored image content, to determine a size of a first display region displaying the currently-inputted image content and a size of a second display region displaying the stored image content.

According to the present structure, when the time difference is large, difference of the size of the first display region and the size of the second display region can be enlarged to notify an audience comprehensively that the time difference is large.

A fourteenth aspect of the present invention provides, in addition to the thirteenth structure of the present invention, the recording/reproducing device, wherein the recording/reproducing control unit makes the size of the first display region approach to the size of the second display region as the difference decreases.

The present structure can notify an audience comprehensively that the time of the image content of the first displaying region approaches to the time of the image content of the second displaying region.

A fifteenth aspect of the present invention provides, in addition to the fourteenth structure of the present invention, the recording/reproducing device, wherein the recording/reproducing control unit makes the size of the first display region gradually approach to the size of the second display region as the difference decreases.

According to the present structure, such a situation can be avoided where an audience is surprised at a sudden enlargement of the size of the first displaying region to the size of the second displaying region.

A sixteenth aspect of the present invention provides, in addition to the fourteenth structure of the present invention, the recording/reproducing device, wherein the difference is measured at a first time interval when the difference does not decrease, and wherein the difference is measured at a second time interval when the difference decreases, the second time interval being shorter than the first time interval.

According to the present structure, when the time difference is unchanged, a large time interval of the processing is taken to suppress a processing burden and electric power consumption. Moreover, when the time difference becomes small, the processing time interval can be made small to make the size of the first displaying region approach the size of the second displaying region gradually.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram illustrating a recording/reproducing device according to Embodiment 1 of the present invention;

FIG. 2 is a block diagram illustrating a recording/reproducing device according to Embodiment 2 of the present invention;

FIG. 3 is a block diagram illustrating a recording/reproducing device according to Embodiment 3 of the present invention;

FIG. 4 is a block diagram illustrating a recording/reproducing device according to Embodiment 4 of the present invention;

FIG. 5 is a block diagram illustrating a recording/reproducing device according to Embodiment 4 (modification 1) of the present invention;

FIG. 6 is a block diagram illustrating a recording/reproducing device according to Embodiment 4 (modification 2) of the present invention;

FIG. 7 is a block diagram illustrating a recording/reproducing device according to Embodiment 4 (modification 3) of the present invention;

FIG. 8 is a block diagram illustrating a recording/reproducing device according to Embodiment 4 (modification 4) of the present invention;

FIG. 9 is a block diagram illustrating a recording/reproducing device according to Embodiment 4 (modification 5) of the present invention;

FIG. 10 is a block diagram illustrating a recording/reproducing device according to Embodiment 5 of the present invention;

FIG. 11 is a block diagram illustrating a recording/reproducing device according to Embodiment 6 of the present invention;

FIGS. 12(a) and (b) are explanatory drawings of a first display region and a second display region according to Embodiment 6 of the present invention; and

FIGS. 13(a) and (b) are explanatory drawings of a size-change timing of the first display region and the second display region according to Embodiment 6 of the present invention.

### DETAILED DESCRIPTION OF THE PREFERRED EMBODIMENTS

Hereafter, embodiments of the present invention are described referring to the accompanying drawings.

### Embodiment 1

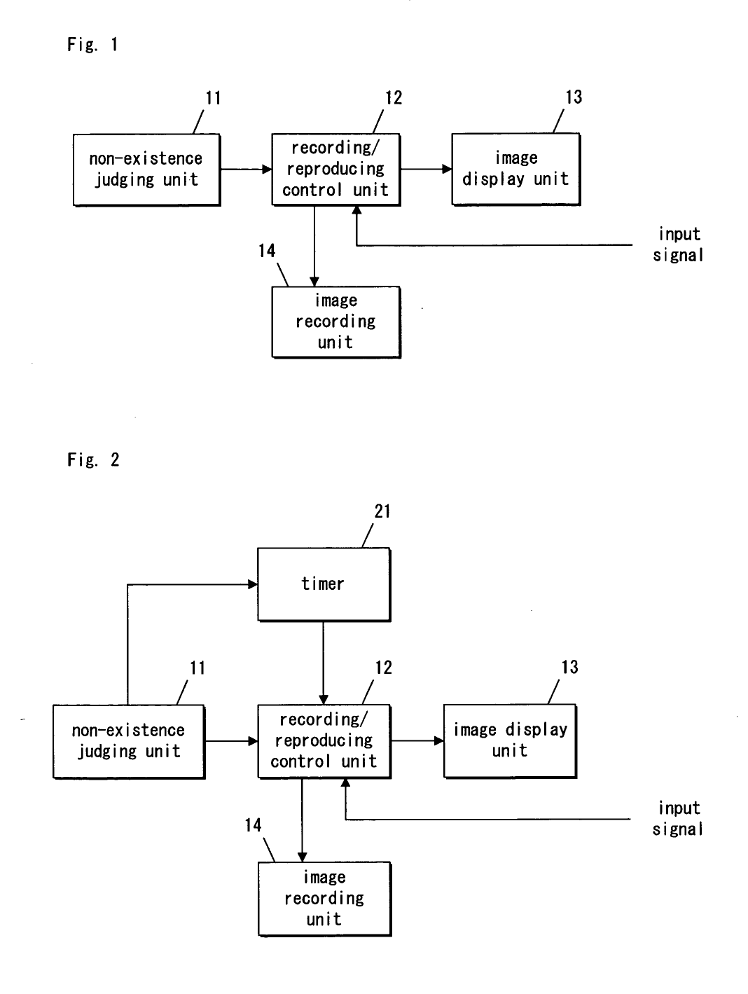

FIG. 1 is a block diagram of a recording/reproducing device in Embodiment 1 of the present invention. As shown in FIG. 1, the recording/reproducing device comprises a non-existence judging unit 11, a recording/reproducing control unit 12, an image display unit 13, and an image recording unit 14.

The image recording unit 14 records an image content which the recording/reproducing device is currently inputting, under the control of the recording/reproducing control unit 12.

The image display unit 13 not only can display the currently-inputted image content under the control of the recording/reproducing control unit 12, but also can simultaneously display the image content which the image recording unit 14 has recorded.

The non-existence judging unit 11 judges states of existence and non-existence of an audience and generates non-existence information.

The recording/reproducing control unit 12 controls whether the image content, which is currently inputted in the image recording unit 14, should be recorded, based on the non-existence information of the non-existence judging unit 11. In addition, the recording/reproducing control unit 12 controls whether the image content recorded in the image recording unit 14 should be reproduced concurrently with the image content that is currently inputted, also based on the non-existence information of the non-existence judging unit 11.

Next, operation of the recording/reproducing device of the present embodiment is explained referring to FIG. 1.

First, the non-existence judging unit 11 judges the states of existence and non-existence of an audience who faces the recording/reproducing device. The non-existence judging unit 11 outputs the non-existence information to the recording/reproducing control unit 12.

When the state of the audience changes from the state of existence to the state of non-existence (that is, the audience is not looking at the recording/reproducing device or disappears), the recording/reproducing control unit 12 instructs the image recording unit 14 to start the recording operation.

Moreover, when the state of the audience changes from the state of non-existence to the state of existence (that is, the audience is looking at the recording/reproducing device or returns), the recording/reproducing control unit 12 sends out the image content that has been recorded on the image recording unit 14 since the state of the audience has become from the state of existence to the state of non-existence (that is, the audience was not looking at the recording/reproducing device or disappeared). The recording control unit 23 makes the image display unit 13 display the image content that is sent out by the image recording unit 14.

At this time, it is assumed that the recording operation to the image recording unit 14 and the reproducing operation from the image recording unit 14 are simultaneously performed.

The image display unit 13 is controlled by the recording/reproducing control unit 12 to display an image content that becomes reproducing object.

The image recording unit 14 records an image content that the recording/reproducing control unit 12 instructs to record. The image recording unit 14 reproduces an image content that the recording/reproducing control unit 12 instructs to reproduce.

As mentioned above, in Embodiment 1, the non-existence judging unit 11 judges whether the audience is in the state of existence or in the state of non-existence, and the recording/reproducing device starts recording image contents when the audience is judged to change from in the state of existence to in the state of non-existence. In other words, the recording/reproducing device of the present embodiment does not automatically record all the image contents, however, the recording/reproducing device records and reproduces the image content only for the period when the audience is not able to watch the image content. Therefore, the simultaneously reproduced image content provides the audience with merits by making up for a part which the audience has failed to watch.

Therefore, the recording/reproducing control unit 12 can reduce power consumed by image encoding that is necessary for recording and image decoding that is necessary for reproducing. The image recording unit 14 also can reduce power consumed by the driver of a recording medium.

### Embodiment 2

FIG. 2 is a block diagram of a recording/reproducing device in Embodiment 2 of the present invention. In FIG. 2, regarding the same elements as in FIG. 1, duplicate explanation is omitted by attaching the same symbols.

As shown in FIG. 2, in addition to the elements shown in FIG. 1, the present recording/reproducing device further comprises a timer 21.

The timer 21 measures: a time when the audience leaves the recording/reproducing device and the audience becomes in the state of non-existence, and a time when the audience returns to the recording/reproducing device and the audience becomes in the state of existence. If the time period of the state of non-existence exceeds a predetermined threshold at the time when the audience returns, the timer 21 performs reproduction control of the image content that is recorded since the time when the audience becomes in the state of non-existence. Contrarily, if the time period of the state of non-existence does not exceed the predetermined threshold when the audience returns in short time, the timer 21 does not perform reproduction control of the image content that is recorded since the time when the audience becomes in the state of non-existence.

As mentioned above, in Embodiment 2, the non-existence judging unit 11 judges whether the audience is in the state of existence or in the state of non-existence and the timer 21 measures the time when the audience is in the state of non-existence. Thereby, the recording/reproducing control unit 12 can judge whether the reproduction control is necessary or not at the time when the audience returns or the audience becomes in the state of existence. When the time period of the state of non-existence does not exceed the predetermined threshold, the recording/reproducing control unit 12 controls not to perform the reproduction control.

Thereby, it can be avoided that a screen of the simultaneous reproduction flickers by repeating ON/OFF. Moreover, the recording/reproducing control unit 12 can reduce power consumed by image encoding that is necessary for recording and image decoding that is necessary for reproducing. The image recording unit 14 also can reduce power consumed by the driver of a recording medium.

### Embodiment 3

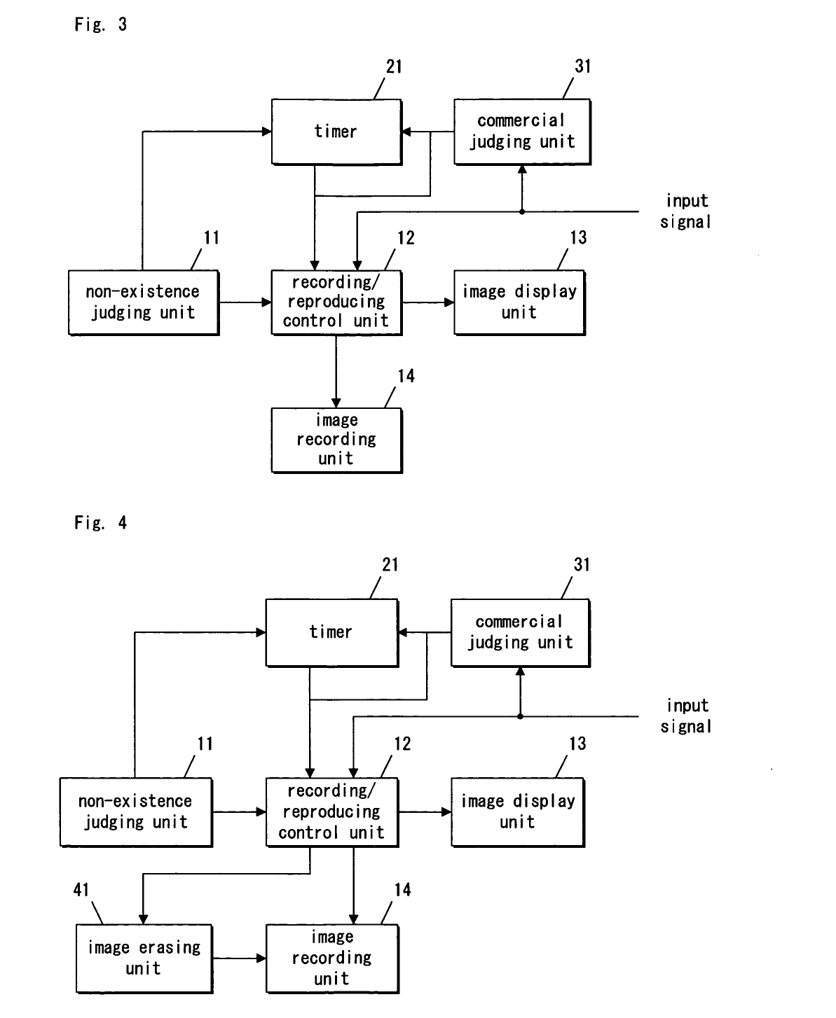

FIG. 3 is a block diagram of a recording/reproducing device in Embodiment 3 of the present invention. In FIG. 3, regarding the same elements as in FIGS. 1 and 2, duplicate explanation is omitted, by attaching the same symbols.

As shown in FIG. 3, in addition to the elements in FIGS. 1 and 2, the present recording/reproducing device further comprises a commercial judging unit 31. Since the technique itself of the commercial judging unit 31 is not involved in the subject matter of the present invention, detailed explanations thereof are herein omitted.

The commercial judging unit 31 judges time when a commercial is started and time when the commercial is ended, thereby the commercial judging unit 31 outputs commercial starting information/commercial ending information to the timer 21.

The timer 21 measures a commercial time interval by the commercial starting information/commercial ending information. Moreover, the timer 21 measures time when an audience becomes in the state of non-existence and time when the audience comes back to be in the state of existence. Then the timer 21 outputs commercial time interval information and non-existence time interval information to the recording/reproducing control unit 12.

The recording/reproducing control unit 12 temporarily suspends recording of the image recording unit 14 during the commercial according to the commercial time interval information. In other words, the time for commercials is skipped; therefore, recording time in the image recording unit 14 is shorter than the time of the image content that is inputted. Due to the temporary suspension, the time of the simultaneously reproduced image content becomes easier to catch up with the time of the currently-inputted image content.

The recording/reproducing control unit 12 holds a value of accumulated intervals of the commercial time interval information outputted from the timer 21, and compares the value of accumulated intervals of the commercial time interval information with a value of the non-existence time interval information. When the values are the same (that is when the time of the simultaneously reproduced image content has caught up with the time of the image content that is currently inputted in the recording/reproducing device), the recording/reproducing control unit 12 makes the image recording unit 14 end both of recording and reproducing.

The reproduction of the image content is, at first, delayed by the time interval of the state of non-existence. However, utilizing the above-described control, the delayed reproducing time (the time of the image content reproduced from the image recording unit 14) can catch up with the recording time (the time of the currently-inputted image content to be recorded in the image recording unit 14) owing to the temporary suspension of recording during commercials. When the delayed reproducing time has caught up with the recording time, recording and reproducing of the image recording unit 14 may be ended.

As mentioned above, in Embodiment 3, using the judgment of the commercial judging unit 31 on the commercial starting time/commercial ending time, the recording/reproducing control unit 12 can judge that recording operation and simultaneous reproducing operation are not necessary to perform, thereby controlling the image recording unit 14 to end recording and reproducing processes.

Therefore, the recording/reproducing control unit 12 can reduce power consumed by image encoding that is necessary for recording and image decoding that is necessary for reproducing. Moreover, the image recording unit 14 also can reduce power consumed by the driver of a recording medium.

### Embodiment 4

FIG. 4 is a block diagram of a recording/reproducing device in Embodiment 4 of the present invention. In addition, in FIG. 4, regarding the same elements as in FIGS. 1, 2 and 3, duplicate explanations thereof are omitted, by attaching the same symbols.

As shown in FIG. 4, in addition to the elements shown in FIGS. 1, 2, and 3, this recording/reproducing device further comprises an image erasing unit 41.

The process of performing the recording/reproducing control using the non-existence judging unit 11 and the process of judging the commercial starting time/commercial ending time by the commercial judging unit 31 are the same as those of Embodiment 3.

The recording/reproducing control unit 12 knows the time of the simultaneously reproduced image content, and the time of the currently-inputted image content in the recording/reproducing device. After the time of the simultaneously reproduced image content has caught up with the time of the currently-inputted image content in the recording/reproducing device, it is judged that the recording and reproducing are not necessary.

The recording/reproducing control unit 12 makes the image erasing unit 41 erase an image content which has become unnecessary for simultaneous reproduction, among the image contents recorded in the image recording unit 14.

When the image erasing unit 41 erases the image content, which has been simultaneously reproduced, from the image recording unit 14, a free space of the image recording unit 14 can be secured, and the free space can be allocated to other purposes.

In Embodiments 1 to 4, the speed of the time axis of the simultaneous reproduction is assumed to be the same as of the time axis of the currently-inputted image content in the recording/reproducing device. However, the speed of the time axis of the simultaneous reproduction may be made faster than the time axis of the currently-inputted image content in the recording/reproducing device (for example, two times faster). Thereby, the simultaneously reproduced image content is easier to catch up with the currently-inputted image content, and it is suitable. If the time of the simultaneously reproduced image content speedily catches up with the time of the currently-inputted image content, the image erasing unit 41 can erase, that much sooner, the image content stored in the image recording unit 14 for reproducing simultaneously; hence, the storage capacity of the image recording unit 14 can be used more efficiently.

Here, the non-existence judging unit 11 in Embodiments 1 to 4 can be constituted as follows.

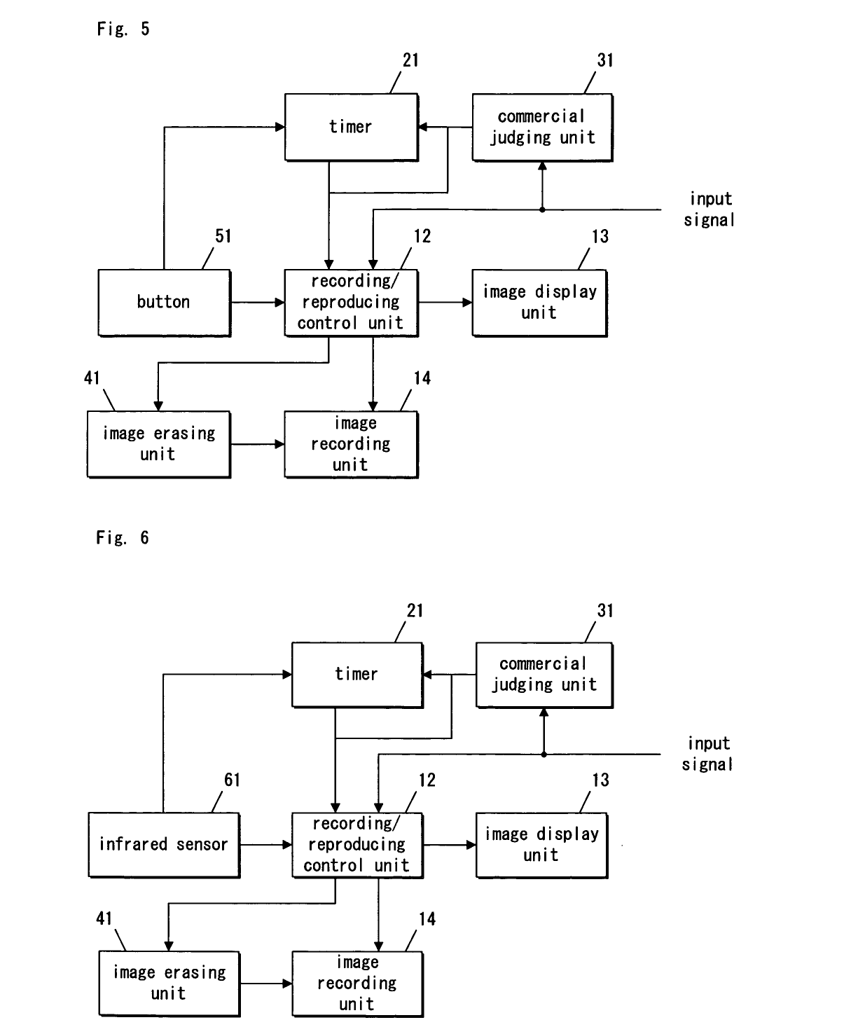

(1) As shown in FIG. 5, the non-existence judging unit 11 may be constituted by a button 51 that notifies the recording/reproducing control unit 12 of depression by an audience.

(2) As shown in FIG. 6, the non-existence judging unit 11 may be constituted by an infrared sensor 61 that notifies the recording/reproducing control unit 12 of shading by an audience.

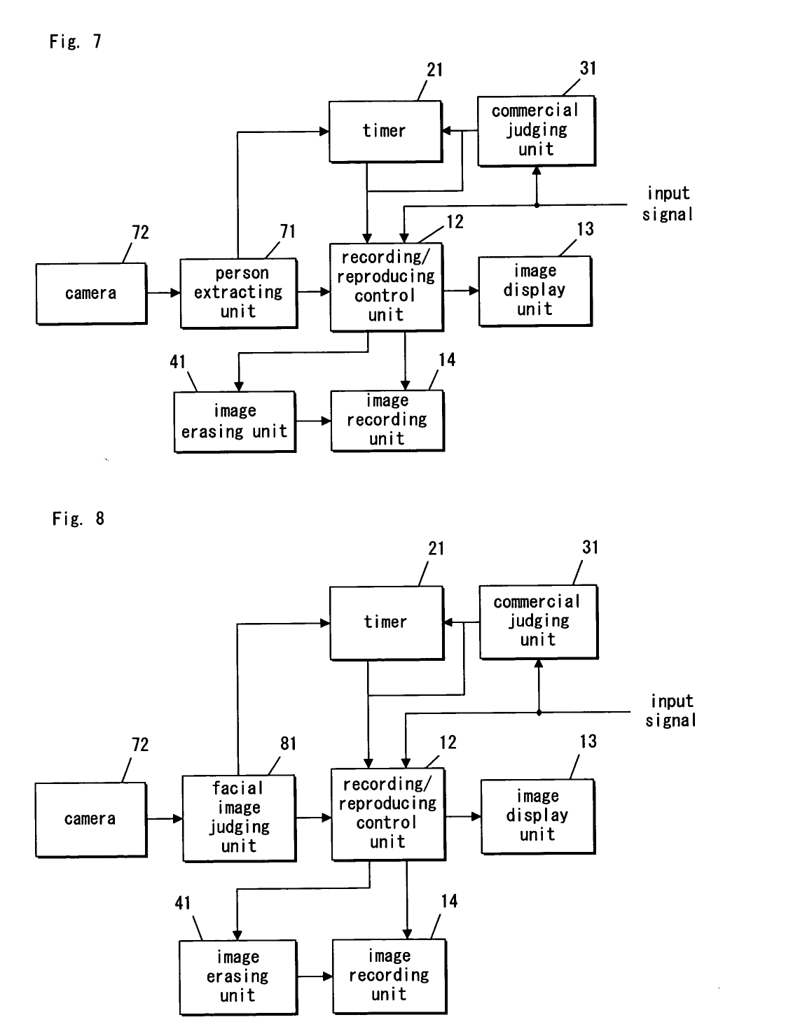

(3) As shown in FIG. 7, the non-existence judging unit 11 may be constituted by a camera 72 generating a camera image within the predetermined range, and a person extracting unit 71 (for example, extraction of a personal outline image by template matching) judging whether an audience is in the state of existence or in the state of non-existence based on the camera image, which the camera 72 generates.

(4) As shown in FIG. 8, the person extracting unit 71 may be constituted by a facial image judging unit 81 (for example, extraction of a facial part image by template matching) detecting a facial image in the camera image, which the camera 72 generates.

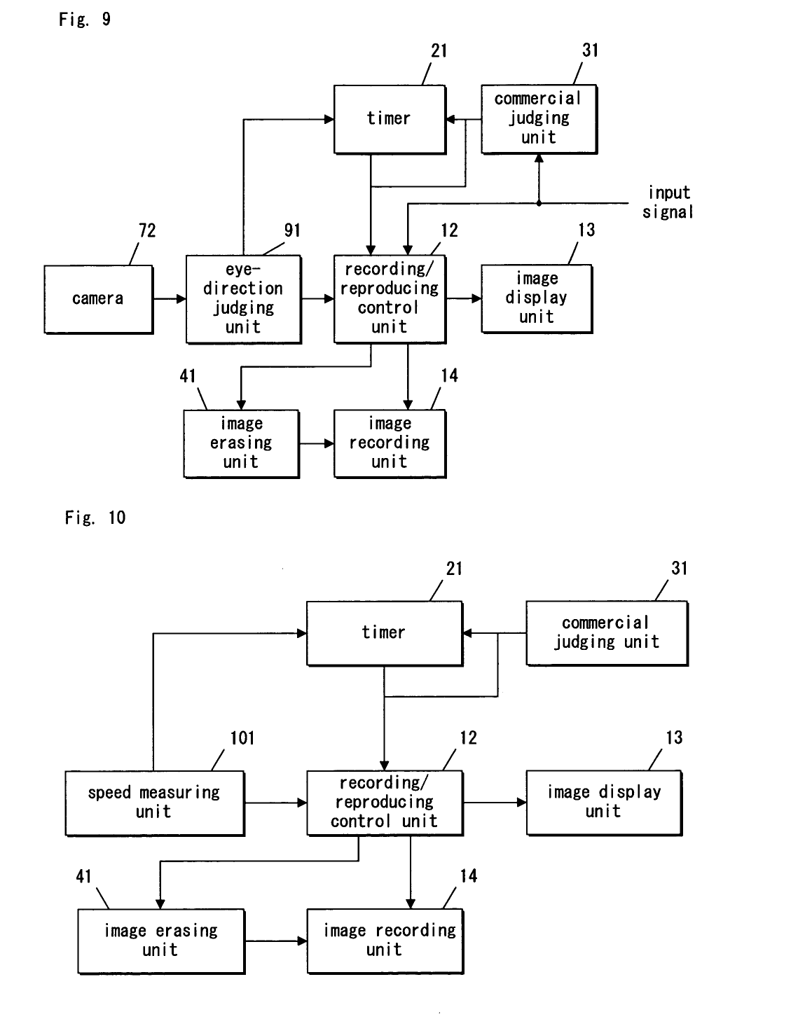

(5) As shown in FIG. 9, the person extracting unit 71 may be constituted by an eye-direction judging unit 91 (for example, extraction of a face direction image by template matching) detecting an eye-direction in the camera image, which the camera 72 generates.

Of course, (1) to (5) may be combined suitably.

### Embodiment 5

FIG. 10 is a block diagram of a recording/reproducing device in Embodiment 5 of the present invention. In FIG. 10, regarding the same elements as in FIG. 4, duplicate explanations thereof is herein omitted, by attaching the same symbols.

In Embodiments 1 to 4, the non-existence judging unit 11 judges the states of existence or non-existence of an audience, and notifies the recording/reproducing control unit 12 of the non-existence information. The recording/reproducing control unit 12 controls whether the currently-inputted image content should be recorded.

In Embodiment 5, the recording/reproducing device is mounted in a mobile object (an automobile is used as an example). As shown in FIG. 10, in addition to the elements shown in FIG. 4, the recording/reproducing device, which is mounted in the automobile, comprises a speed measuring unit 101. The speed measuring unit 101 measures the moving speed of the mobile object, and notifies the recording/reproducing control unit 12 of the speed information.

In general, the image display unit 13 of the recording/reproducing device, which is mounted in the automobile, does not display the image content such as television while driving, in order to prevent traffic accidents. Alternatively, the image display unit 13 turns off the screen or masks the image content with the other images. In other words, the driver and passengers of the automobile cannot watch a desired image content, and often fail to watch the image content.

In such a case, the driver or the passengers are present or physically exist close to the recording/reproducing device as the audiences. However, the driver or the passengers in such situation are substantially identified as the audiences in the state of “non-existence”, since they can not watch the image content.

Therefore, in this specification, the term “non-existence” has wider meaning than usual (physical meaning of “non-existence). Thus, the term “non-existence” substantially includes a situation that can be considered as “non-existence” because an audience is somehow not able to watch an image content. On the other hand, the term “existence” is used to mean the opposite situation of the term “non-existence”.

When an audience has failed to watch an image content because the audience was in the state of “non-existence”, making up for the image content improves convenience for the audience in Embodiment 5 as in Embodiments 1 to 4.

Accordingly, the speed measuring unit 101 measures the moving speed of a mobile object, and notifies the recording/reproducing control unit 12 of the speed information. When the speed information indicates that the moving speed is zero or almost zero, the audience is not prohibited to watch an image content; therefore, the audience is in the state of “existence”. When the speed information indicates that the moving speed can not be recognized as zero, the audience is prohibited to watch the image content; therefore, the audience is in the state of “non-existence”.

Thus, the non-existence judging unit in Embodiment 5 is constituted by the speed measuring unit 101. Similarly to employing the non-existence judging unit 11 of Embodiments 1 to 4, the recording/reproducing control unit 12 in Embodiment 5 can recognize a change from the state of “existence” to the state of “non-existence” or from the state of “non-existence” to the state of “existence”. Therefore, the speed information of the present embodiment is substantially the same as the non-existence information of Embodiments 1 to 4.

When the audience has changed from in the state of existence to in the state of non-existence (when the automobile starts moving), the recording/reproducing control unit 12 in Embodiment 5 instructs the image recording unit 14 to start recording based on the speed information.

When the audience has changed from in the state of non-existence to in the state of existence (when the automobile stops moving), the recording/reproducing control unit 12 sends out the image content recorded on the image recording unit 14 since the audience has changed from in the state of existence to in the state of non-existence (when the automobile starts moving) to the image display unit 13. Then the image display unit 13 displays the image content.

At this time, it is assumed that the recording operation to the image recording unit 14 and the reproducing operation from the image recording unit 14 are performed simultaneously.

The recording/reproducing control unit 12 controls the image display unit 13. The image display unit 13 displays the image content that is for reproducing.

The image recording unit 14 records the image content which the recording/reproducing control unit 12 has specified. The image recording unit 12 reproduces, as well, the image content which the recording/reproducing control unit 12 has specified.

As mentioned above, in Embodiment 5, the speed measuring unit 101 measures the speed of a mobile object, thereby the state of “existence” or the state of “non-existence” of the audience is substantially judged. When the state becomes “non-existence”, recording starts.

In other words, the recording/reproducing device of the present embodiment does not automatically record all the image contents, however, the recording/reproducing device records and reproduces the image content only for the period when the audience is not able to watch. Therefore, the simultaneously reproduced image content provides the audience with merits by making up for a part which the audience has failed to watch.

Therefore, the recording/reproducing control unit 12 can reduce power consumed by image encoding that is necessary for recording and image decoding that is necessary for reproducing. Moreover, the image recording unit 14 also can reduce power consumed by the driver of a recording medium.

### Embodiment 6

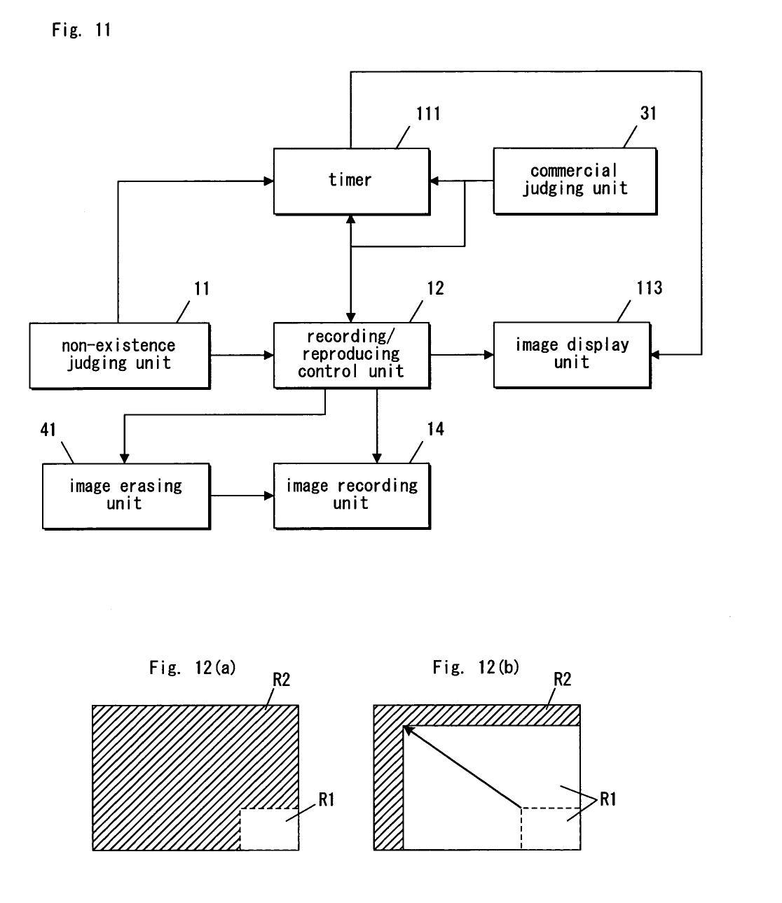

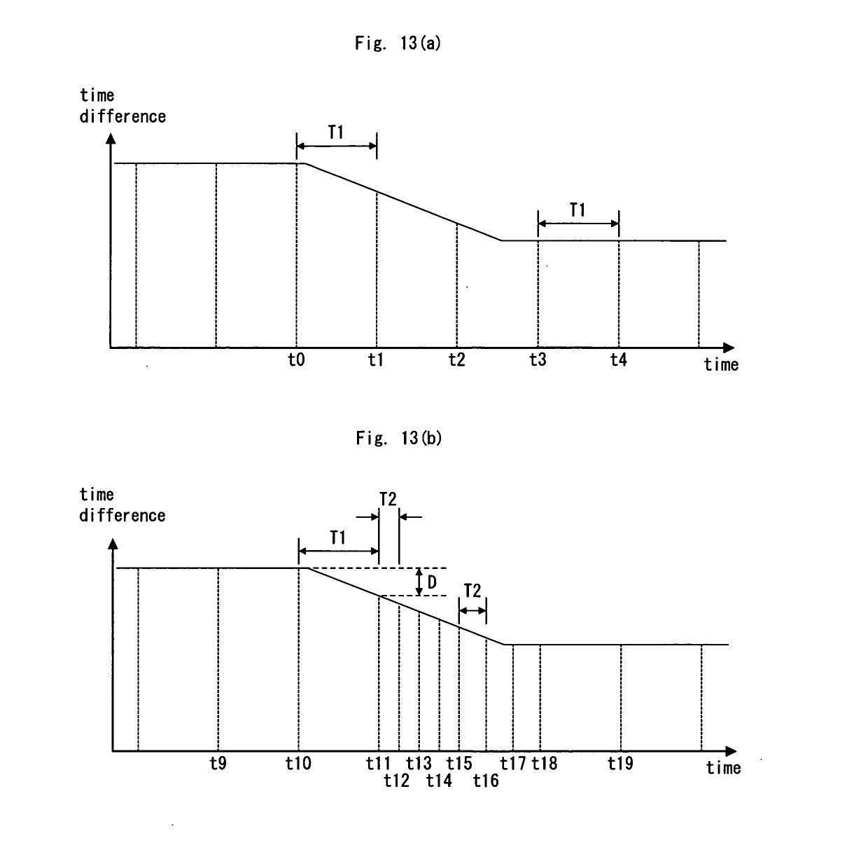

FIG. 11 is a block diagram of a recording/reproducing device in Embodiment 6 of the present invention. FIGS. 12(a) and (b) explain first and second display regions in Embodiment 6 of the present invention. FIGS. 13(a) and (b) explain size-change timing of the first and second display regions in Embodiment 6 of the present invention. As shown in FIG. 12(a), the first display region R1 (a rectangle without slashes) displays the currently-inputted image content and the second display region R2 (a rectangle with slashes) displays the image content recorded in the image recording unit 14. The recording/reproducing control unit 12 of Embodiment 6 defines the size of the first display region R1 and the size of the second display region R2, based on the change of the time difference between the currently-inputted image content and the image content recorded in the image recording unit 14.

In the present embodiment, the size of the second display region R2 is assumed to be constant. When the time difference is large, the difference of the sizes of the first display region R1 and the second display region R2 is made larger, as shown in FIG. 12(a). Thereby, it is easier for audiences to recognize that the time difference is large.

When the time difference becomes smaller, the recording/reproducing control unit 12 makes the size of the first display region R1 gradually approach the size of the second display region R2 in proportion to the time difference, as shown in FIG. 12(b). The size of the first display region R1 does not become larger like the size of the second display region R2 all the sudden. Thereby, the situation in which the audience gets surprised by a sudden change of the size can be avoided.

More specifically, a timer III adjusts timing in renewing the size of the first display region R1, by adopting two time intervals, T1 and T2 (T1>T2).

FIG. 13(a) shows an example of a change of the time difference when adjusting the timing in renewing the size only by the longer time internal T1. In other words, the time difference between time t3 and time t4 on the horizontal axis is T1, which is a constant value.

In this example, the time difference shown on the vertical axis is constant up to time t0. For example, there is no commercial, and the time of the recorded image content, which is displayed on the second display region R2, is delayed for the constant time difference (for example 5 minutes), compared with the actual time of the currently-inputted image content, which is displayed on the first display region R1.

When a commercial is put on the air and recording the image content is skipped from time t0 until right before time t3, then the time difference shown on the vertical axis becomes smaller by the time duration skipped (for example, 5 minutes−2 minutes=3 minutes, with the skipped time of 2 minutes).

When recording the image content is not skipped after time t3, the time difference shown on the vertical axis is unchanged, unless the speed of recording and the speed of reproducing differ.

In general, from the point view of power consumption, it is desirable that the size-renewing timing for the first display region R1 should be by the longer time interval T1, as shown in FIG. 13(a). However, if the time interval is too long, the time difference defined by the vertical axis in FIG. 13 also becomes too large. Therefore, the size of the first display region R1 becomes suddenly larger.

The present embodiment employs two time intervals, a longer time interval T1 and a shorter time interval T2, at which the timer 111 counts size-renewing timing. At the same time, the recording/reproducing control unit 12 stores a threshold TH (for example, 30 seconds) for a change of the time difference.

As shown in FIG. 13(b), the recording/reproducing control unit 12 sets the longer time interval T1 in the timer III and starts renewing the size of the first display region R1. For example, the timer 111 counts a size-renewing timing at time t9, then counts a next size-renewing timing at time t10, then, the recording/reproducing control unit 12 evaluates a difference D between the time difference shown on the vertical axis at time t9 and the time difference at time 10. Then the recording/reproducing control unit 12 compares the difference D and the threshold TH in magnitude. Here, since the difference D=0, the result of D<TH is obtained. At this time, the recording/reproducing control unit 12 judges that the time interval, which should be set in the timer 111, may remain to be the longer time interval T1.

At time t11, the recording/reproducing control unit 12 evaluates similarly the difference D, then the result of D>TH is obtained. According to the result, the recording/reproducing control unit 12 changes the time interval, which should be set in the timer III, to the shorter time interval T2. The recording/reproducing control unit 12 defines the size of the first display region R1 in proportion to the time difference of the vertical axis at time t11, and changes the display state of the image display unit 113 correspondingly.

After that, while recording the image content is skipped (up to time t17), the recording/reproducing control unit 12 renews the size of the first display region R1 gradually by the short time interval T2, in proportion to the time difference of the vertical axis at each time t11 to t17. The recording/reproducing control unit 12 changes the display state of the image display unit 113 correspondingly. As the result, the size of the first display region R1 changes smoothly to approach the size of the second display region R2.

At time t18, the recording/reproducing control unit 12 evaluates a difference D between the time difference shown on the vertical axis at time t17 and the time difference at time 18. Then the recording/reproducing control unit 12 compares the difference D and the threshold TH in magnitude. Here, since the difference D=0, the result of D<TH is obtained. According to the result, the recording/reproducing control unit 12 determines that the time interval, which should be set in the timer 111, is the longer time interval T1. As the result, the size-renewing timing of the first display region R1 is counted at the longer time interval T1, thereby the power consumption can be controlled.

As mentioned above, since the size of the first display region can be changed smoothly while saving the power consumption, the display result that is readily acceptable by audiences can be realized.

According to the recording/reproducing device related to the present invention, the simultaneous reproduction can make up for image contents which an audience has failed to watch because the audience was in the state of non-existence. In addition, the power consumption can be saved by rationally shortening the automatic recording for the simultaneous reproduction.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

1. A recording/reproducing device, comprising:
an image recording unit operable to store a currently-inputted image content;
an image display unit operable to display a stored image content stored by said image recording unit and the currently-inputted image content;
a judging unit operable to judge whether an audience exists or not, thereby generating non-existence information that includes an item indicating one of states of existence and non-existence of the audience;
a recording/reproducing control unit operable, according to the non-existence information generated by said judging unit, to control whether said image recording unit should store the currently-inputted image content, and further operable to control whether said image display unit should concurrently display both the stored image content and the currently-inputted image content; and
a timer operable to measure a time when the item of the non-existence information changes from the state of existence to the state of non-existence and a time when the item of the non-existence information changes from the state of non-existence to the state of existence, thereby generating a measured result.

2. The recording/reproducing device as claimed in claim 1, wherein said recording/reproducing control unit makes said image recording unit begin to store the currently-inputted image content when the item of the non-existence information changes from the state of existence to the state of non-existence, and
wherein said recording/reproducing control unit judges, referring to the measured result generated by said timer, whether said image display unit should concurrently display both the stored image content and the currently-inputted image content when the item of the non-existence information changes from the state of non-existence to the state of existence.

3. The recording/reproducing device as claimed in claim 2, wherein said recording/reproducing control unit makes said image display unit begin to concurrently display both the stored image content and the currently-inputted image content when the item of the non-existence information changes from the state of non-existence to the state of existence and when the measured result generated by said timer exceeds a predetermined threshold.

4. The recording/reproducing device as claimed in claim 2, wherein said recording/reproducing control unit makes said image display unit end to concurrently display both the stored image content and the currently-inputted image content when a reproducing time of the stored image content catches up with a reproducing time of the currently-inputted image content.

5. The recording/reproducing device as claimed in claim 4, further comprising:
a commercial judging unit operable to judge whether the currently-inputted image content is an image content of a commercial,
wherein said recording/reproducing control unit makes said image recording unit suspend storage of the currently-inputted image content while said commercial judging unit judges that the currently-inputted image content is the image content of the commercial, the storage having begun when the item of the non-existence information changed from the state of existence to the state of non-existence.

6. The recording/reproducing device as claimed in claim 4, further comprising:
an image erasing unit operable to erase an image content stored by said image recording unit,
wherein said recording/reproducing control unit makes said image erasing unit erase an image content that has been stored by said image recording unit and has become unnecessary for concurrently displaying both the stored image content and the currently-inputted image content.

7. The recording/reproducing device as claimed in claim 1, wherein said judging unit includes:
a button operable to notify said recording/reproducing control unit that said button has been pressed down by the audience.

8. The recording/reproducing device as claimed in claim 1, wherein said judging unit includes:
an infrared sensor operable to notify said recording/reproducing control unit that said infrared sensor has been shaded by the audience.

9. The recording/reproducing device as claimed in claim 1, wherein said judging unit includes:
a camera operable to shoot a predetermined area to generate an camera image; and
a person extracting unit operable to judge whether the audience exists in the camera image generated by said camera.

10. The recording/reproducing device as claimed in claim 9, wherein said person extracting unit includes:
a facial image judging unit operable to detect a facial image in the camera image generated by said camera.

11. The recording/reproducing device as claimed in claim 9, wherein said person extracting unit includes:
an eye-direction judging unit operable to detect an eye-direction of the audience in the camera image generated by said camera.

12. The recording/reproducing device as claimed in claim 1, wherein said image recording/reproducing device is mounted in an automobile, and
wherein said judging unit includes:
a speed measuring unit operable to measure a speed of the automobile to generate speed information, thereby notifying said recording/reproducing control unit of the speed information.

13. The recording/reproducing device as claimed in claim 1, wherein said recording/reproducing control unit operable, according to a change of a difference between a reproducing time of the currently-inputted image content and a reproducing time of the stored image content, to determine a size of a first display region displaying the currently-inputted image content and a size of a second display region displaying the stored image content.

14. The recording/reproducing device as claimed in claim 13, wherein said recording/reproducing control unit makes the size of the first display region approach to the size of the second display region as the difference decreases.

15. The recording/reproducing device as claimed in claim 14, wherein said recording/reproducing control unit makes the size of the first display region gradually approach to the size of the second display region as the difference decreases.

16. The recording/reproducing device as claimed in claim 14, wherein the difference is measured at a first time interval when the difference does not decrease, and wherein the difference is measured at a second time interval when the difference decreases, the second time interval being shorter than the first time interval.
